(19) United States
(12) Patent Application Publication
(10) Pub. No.: US 2012/0005702 A1
(43) Pub. Date: Jan. 5, 2012

(54) Improved Television and Video System

(75) Inventor: Kenneth William Tindell, Suffolk (GB)

(73) Assignee: VIDIACTIVE, LTD., Sheffield (GB)

(21) Appl. No.: 13/255,121

(22) PCT Filed: Apr. 7, 2010
(86) PCT No.: PCT/EP2010/054614

§ 371 Date: Sep. 7, 2011

(30) Foreign Application Priority Data
Apr. 8, 2009 (GB) 0906272.0
Nov. 2, 2009 (GB) 0919222.0

(51) Int. Cl. H04N 7/16

(52) U.S. Cl. 725/14

(57) ABSTRACT

An improved television and video system uses a system device which is connected to a multiplicity of television and video devices. The system device is configured to monitor a TV or video source regularly watched by a viewer and provides TV programs or videos to be in accordance with a viewer's interest.

This invention relates to an improved television and video system.

Conventional television and video systems allow limited functionality to be achieved in terms of display, handling and other actions and interactions between television and video images and a viewer.

It has been realized by the present applicant that much greater functionality can be achieved in a television and video system in which the system is intelligent in its operation. In other words, it has been determined that viewer interaction with the system allows the system to become tuned to the desires and wishes of individual or groups of viewer and can allow the system to obtain, record and/or play a desired TV or video to the viewer.

Thus and in accordance with the present invention there is provided an improved television and video system comprising a system device connected to multiple TV and video sources and which is operable to obtain TV and video signals from one or more of said sources, said system device also being operable to monitor the TV and video being watched by a viewer and being operable to obtain from one or more of said sources video and TV signals appropriate to that viewers tastes.

With this arrangement it is possible to provide a system which is intelligent and smart and interacts with a viewer both directly and indirectly to allow greater viewer targeted functionality.

The invention will now be described further by way of example only with reference to the attached drawings of what:

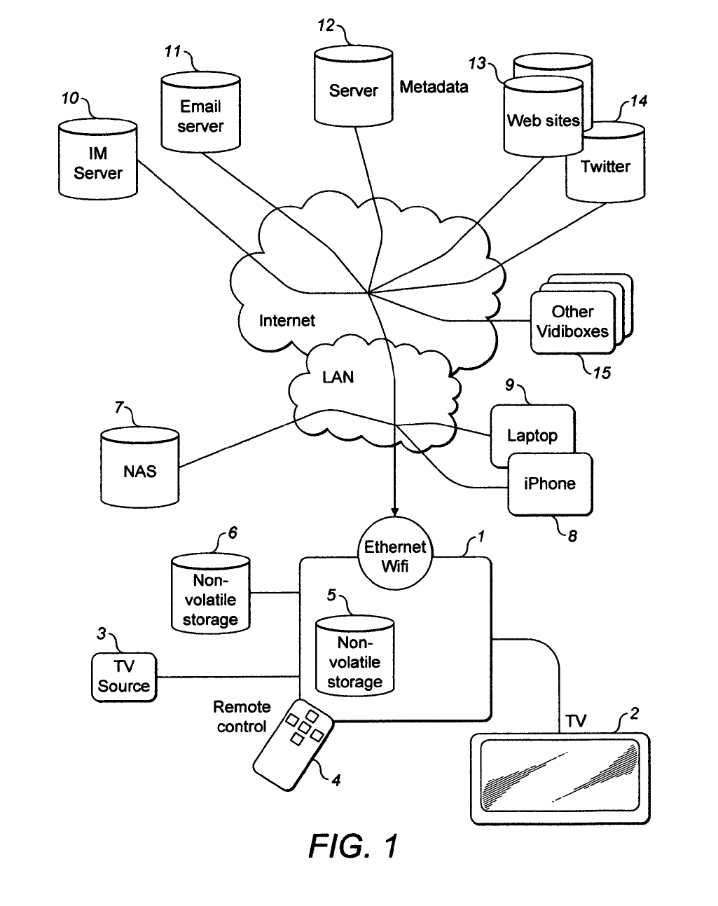

FIG. 1 shows a diagrammatic form of an embodiment of the system in accordance with the invention.

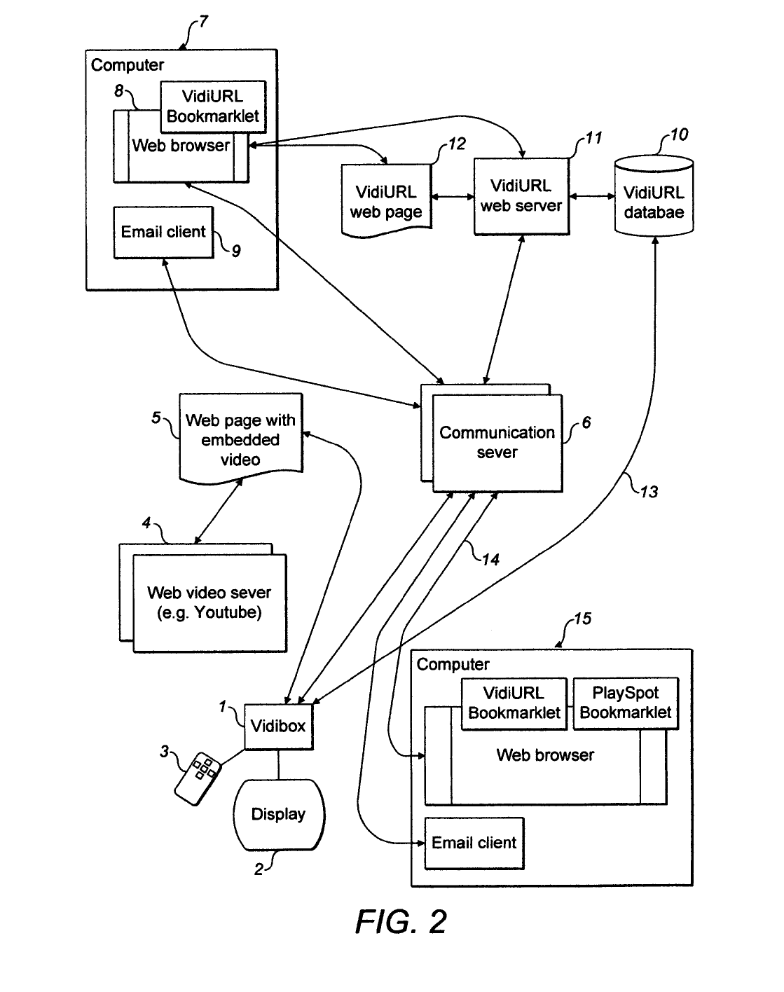

FIG. 2 shows in diagrammatic form, one form of embodiment of suitable architecture of a system in accordance with the present invention;

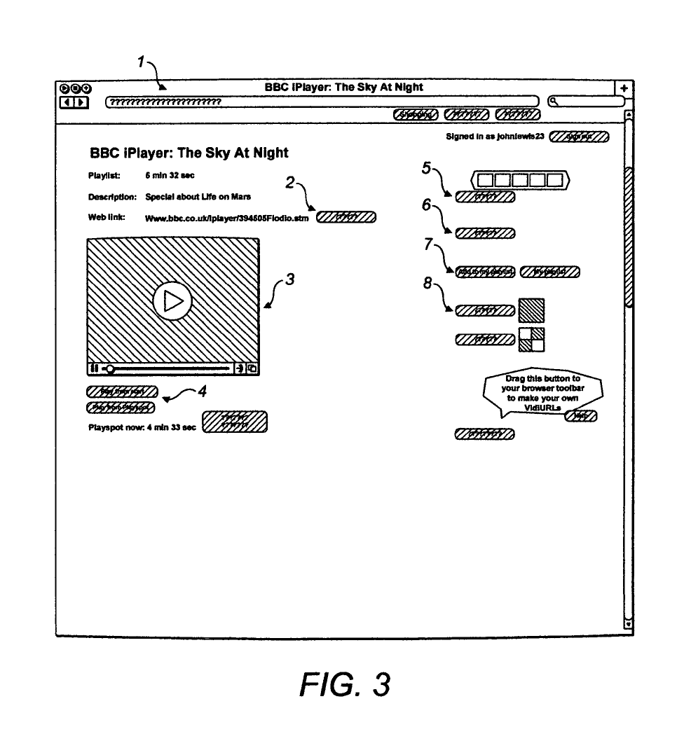

FIG. 3 shows a diagrammatic representation of a web page developed during the operation of the system;

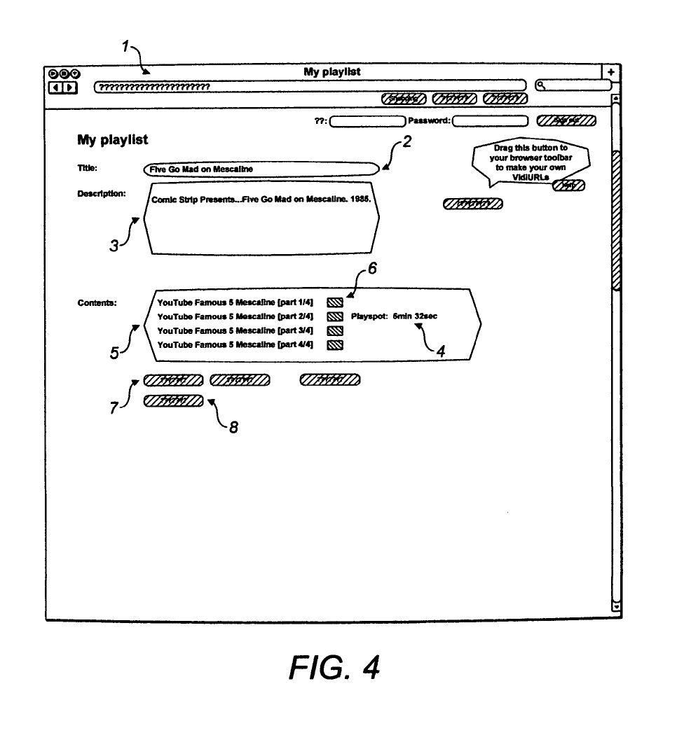

FIG. 4 shows an example of a playlist webpage;

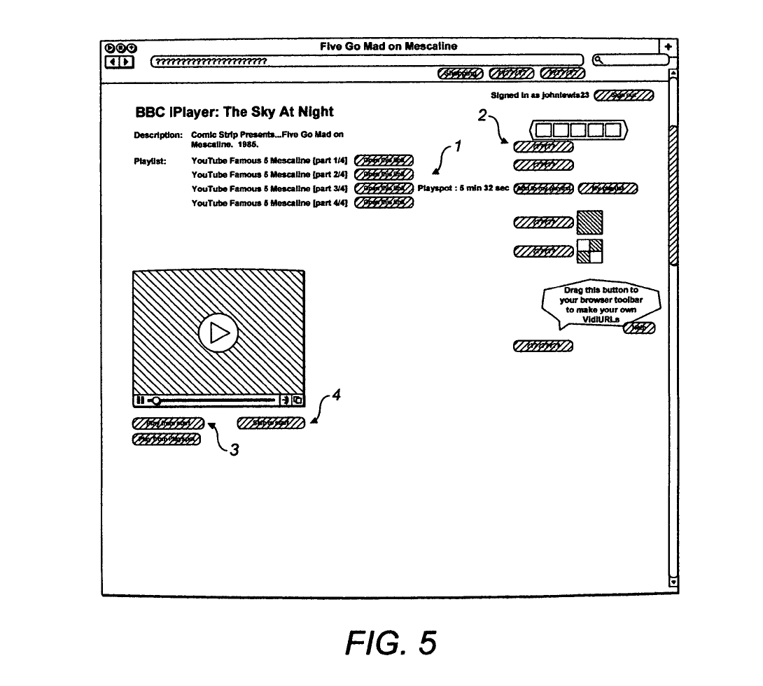

FIG. 5 shows one example of a playlist page;

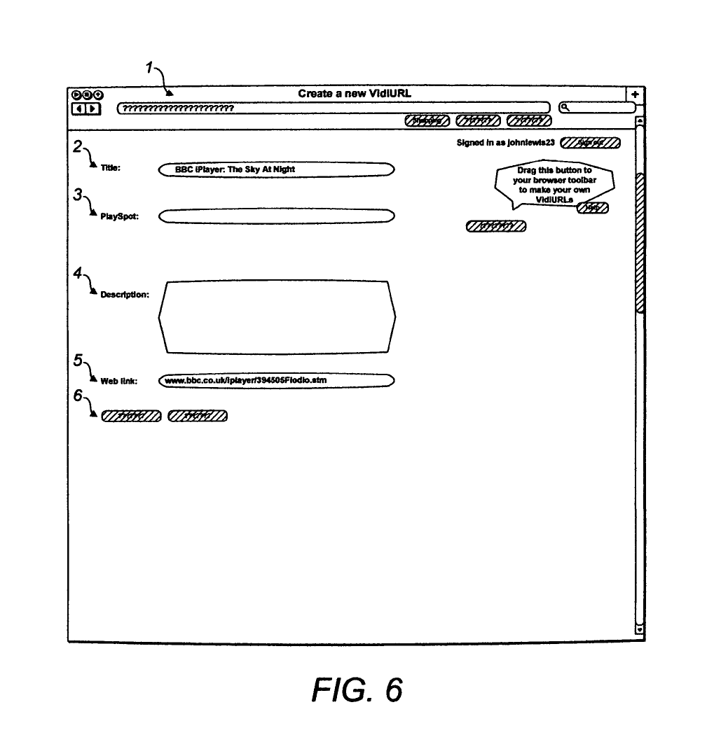

FIG. 6 shows a example of a playlist generated as a form; and

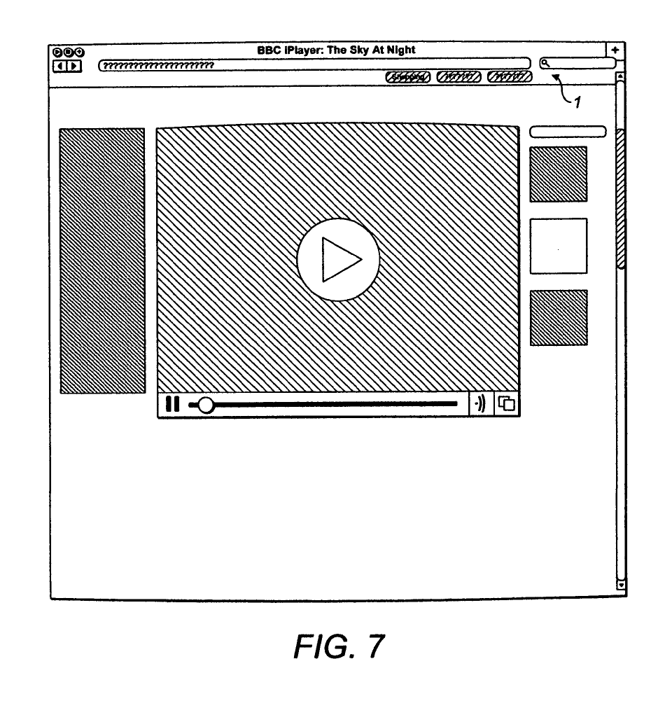

FIG. 7 shows an example of a bookmarklet produced in the operation of the present invention.

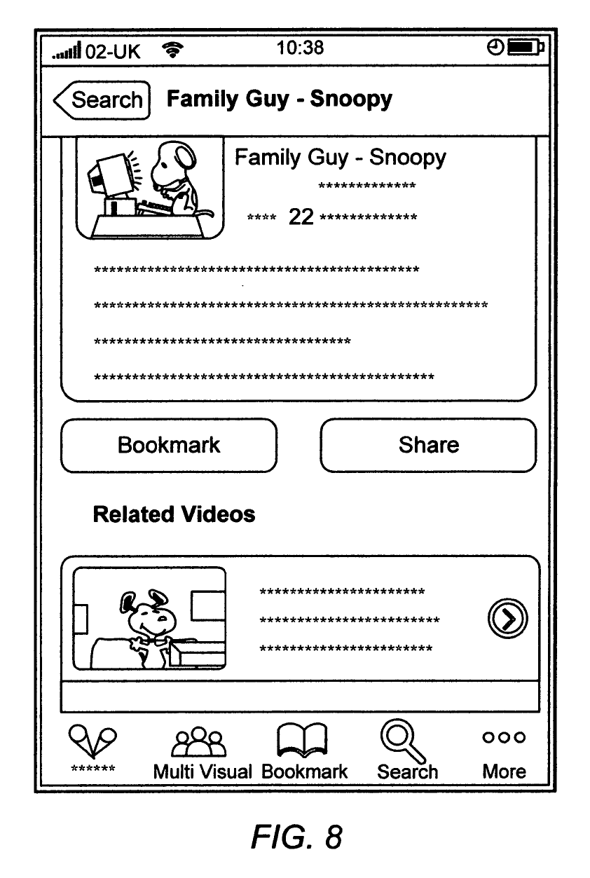

FIGS. 8-12 show representations of examples of screenshot generated during use of the system.

Referring now to FIG. 1, this shows one embodiment of a system in accordance with the present invention in schematic form.

The system of the invention comprises a TV system (hereinafter referred to as a “Vidibox”) (1). The box is connected to the Internet (17) and to the local area network (16) via a standard protocol, for example, but not limited to, Ethernet or WiFi. The box obtains video signals from conventional TV sources (3) from any of satellite, DVB-T, analogue, and cable TV receiver hardware. The box is also able to obtain video signals from the Internet by connecting to one of a Multiplicity of conventional web sites that serve video in conventional forms (e.g. Adobe Flash video). The TV and video signals are displayed on a conventional TV set (2) using SCART, HDMI, VGA or other standard connections.

The Vidibox may optionally access conventional non-volatile storage (e.g. hard disk, solid state) provided internally of the box (5), externally connected (6) using conventional technologies (e.g. USB, Firewire) or optionally one or more conventional network attached storage (NAS) devices (7) connected using the LAN using standard mechanisms (e.g. CIFS, NFS, AFP).

The Vidibox can also be connected to conventional laptops (9), mobile phones (8) and similar devices through the LAN with standard IP protocols (e.g. Bonjour, UPnP, TCP/IP). The Vidibox is able to exchange messages with conventional devices connected to the Internet by using conventional instant message (IM) protocols (e.g. XMPP) from an account associated with the box on a conventional IM server (10). The Vidibox box can also send and receive emails using an account on a conventional email server (11) using conventional protocols (e.g. IMAP). The Vidibox is also able to exchange messages with other Vidiboxes (15) connected to the Internet and also with a special server, or servers, Adapted to communicate with the Vidibox (12).

The system hereinbefore described is shown schematically in the figure and the system can be operated in accordance with the following examples to achieve unique improved features and functionality of a TV system.

### Smart PVR Recording

The personal video recorder (PVR) in the Vidibox records TV programmes to non-volatile storage for later playback. It decides what to record based on a list of programmes ('feeds'). A feed is chosen by the viewer directly or by speculation (this aspect of the invention is described later). A specific recording of a programme is identified by continually matching the feeds against an electronic programme guide (EPG) which is obtained from the TV signals (e.g. the standard DVB-T guide) or from a server on the internet.

The TV hardware will have a limit on the number of concurrent recordings possible and on the size of recordings that can be stored in the available disk space. Clashes are consequently inevitable. The Vidibox PVR function resolves clashes automatically by identifying repeated programmes in the schedule (e.g. there are many “+1” channels that repeat the programmes on the main channel with a delay of one hour) using conventional fuzzy matching algorithms on the programme description, and by assigning priorities to episodes of programmes. A conventional optimisation algorithm (e.g. Branch-and-Bound, Simulated Annealing) is used to schedule recordings to maximise the “utility” of recordings made and to determine which already-recorded programmes may be discarded to release storage space for a new recording. Recordings that fail (e.g. significant loss of signal) are automatically re-recorded.

The priority for new recordings is set by factors including, but not limited to, the following:

1. The priority is higher if the viewer habitually watches all the episodes in a series in sequence. Watching every episode of a serialised drama is very different to watching cartoons: missing an episode of the former is very disruptive; missing an episode of the latter is not.
2. The priority is higher if the programme or the feed from which it has been taken has been explicitly marked “keep”.
3. The priority is lower if the programme will be available on an existing catch-up TV service on the web (e.g. the BBC iPlayer, Hulu) and if the viewer is not absent before it expires. Absence can be inferred (e.g. based on a recent lack of direct interaction with the Vidibox or a habitual lack of direct interaction in a weekly cycle) or known by explicit information (e.g. the viewer set the Vidibox into ‘holiday mode’).
4. The priority is lower if the programme is a repeat and the original has been watched recently.
5. The priority is higher if the programme is likely to be very interesting to the viewer. This is assessed by correlating the viewing habits of different viewers of different Vidiboxes (this aspect of the invention is described in more detail later) augmented with metadata from conventional Internet sources (for example the movie ratings on the IMDB website)

The priority for already-recorded programmes is set by factors including, but not limited to, the following:

1. The priority is lower if the recording has been explicitly marked “deleted” (i.e. the viewer performed a deletion operation)
2. The priority is lower if there exists a transcoded copy of the recording (this aspect of the invention is described later).
3. The priority is lower if the recording was made speculatively (this aspect of the invention is described later).
4. The priority is higher if the recording is likely to be very interesting to the viewer. This is assessed by correlating the viewing habits of different viewers of different Vidiboxes (this aspect of the invention is described later).
5. The priority is higher if the recording or the feed from which it has been taken has been explicitly marked “keep”.
6. The priority is lower if the programme has been watched. This can be determined if the viewer watches a non-trivial amount of the programme towards the end of the recording.
7. The priority is higher if the viewer added tags or bookmarks to the programme after watching it.

In conventional PVR designs it is common to record padding around a TV programme to allow for small inaccuracies in the transmission schedule. A consequence of this is to treat contiguous TV programmes from the same channel as potentially clashing since the padding at the end from the first TV programme overlaps with the padding beginning the new TV programme. Some PVR designs treat this as a clash and recordings may fail. Some recognise this situation and remove the end padding of the first TV programme and the beginning padding of the second TV programme. This solution is not ideal since the end of the first recording may contain material from the second TV programme (or vice versa). Deleting one of these programmes after watching risks losing the material from the other before it has been watched. The Vidibox PVR recording function solves this problem as follows:

1. The scheduled recordings of the two TV programmes are amalgamated into a single scheduled recording with start and end padding applied to the new recording.
2. After the completion of the original first recording a copy is made of the amalgamated recording in progress up to the completion of the end padding of the first original recording. The amalgamated recording is edited to delete the first part of the recording up to the beginning of the start padding for the second TV programme. An embodiment of the invention using a copy-on-write file system to store recordings can optimise the copying process.
3. In a typical embodiment of the invention the copy and editing points will be at an approximate time due to the nature of compressed digital TV frames.
4. If an embodiment is to use conventional operating system file handling then careful design of the PVR recording function is necessary to ensure that concurrent access to a shared file is handled properly. Such an embodiment will use buffering and concurrency control mechanisms (e.g. semaphores).
5. The PVR function may play a TV programme back at any point after recording has reached the beginning of the start padding of the TV programme. The PVR function keeps track of where a TV programme is located within a given recording storage system so that if part of the recording is copied and edited as described in step 2 then the reference is changed to the correct offset within the original file or to the new file.
Smart Communication with the Viewer

Each Vidibox has an IM and an email account on conventional servers. The viewer may communicate with the Vidibox using a conventional device capable of sending email or IM messages (e.g. iPhone, laptop). If the viewer sends a URL for a video on a web site then the Vidibox will operate on the link as follows:

1. If the sender is the viewer (or one of several viewers registered to the Vidibox) and the message requests immediately playback of the video then the video decode function of the Vidibox is used to being showing the video (the internet video decode aspect of the invention is described later).
2. If the sender is marked as a friend of the viewer or the message requests storage of the link then the Vidibox adds the link to the video to an inbox from where it can be selected for playback by the viewer. The message may include tags and these are stored with the link (the tagging aspect of the invention is described later).
3. If the sender is unknown then the Vidibox deletes the message or holds it in a special area depending on preferences expressed by the viewer.

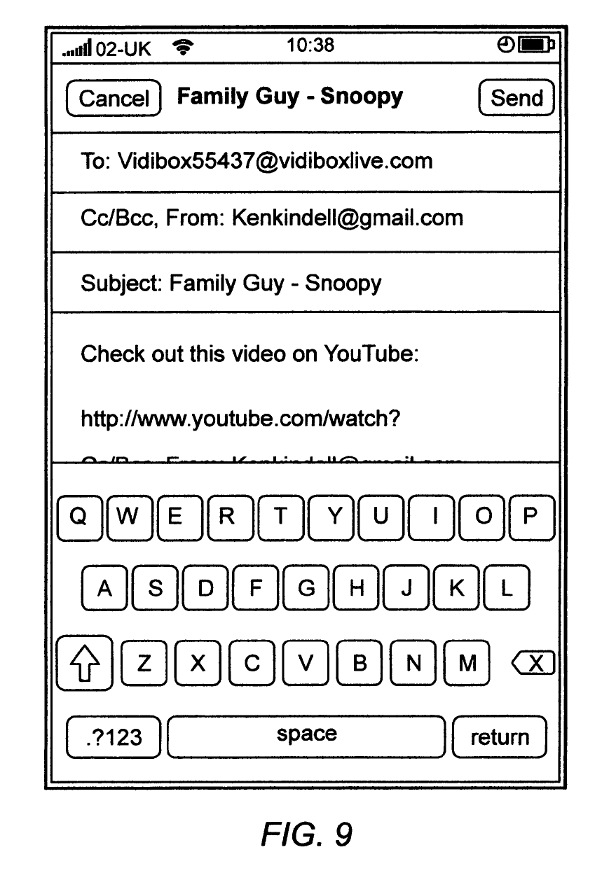

FIGS. 8 and 9 show examples of a typical embodiment using an iPhone and its YouTube application. The user of the iPhone finds a video with the iPhone YouTube application as seen in FIG. 8.

The user then decides to send the video to a particular Vidibox by tapping “Share” as seen in FIG. 9.

Typically a user will add the Vidibox email address to the contact details of the owners of the box, so instead of “vidibox55437@vidiactive.com” they merely look up “John Doe” and select “vidibox” instead of “work” or “home” email.

The sender may annotate the email with details of how to handle it. For example, he may write “tags:” followed by a list of keywords. These will be attached to the video to allow the viewer to find it more easily. He may write “play” to instruct the Vidibox to play it immediately.

The Vidibox initiates messages to the viewer when the viewer expresses an interest at a particular point in the playback of a TV programme or internet video (e.g. to express interest in an advertised product or service). When playing a recorded TV programme or an Internet video the Vidibox communicates the details of the playback over the Internet using conventional protocols (e.g. XMPP) to a server holding timecode metadata in a conventional database. This metadata marks particular points in videos and TV programmes and for each point stores one or more URLs. The server indexes the database with the content to be played back and if there is timecode metadata for the content it sends it back to the Vidibox. From a point near to each timecode to a point shortly after the timecode the Vidibox indicates to the viewer with visual and audible motifs that information may be requested. If the user expresses interest in the information then the Vidibox communicates to the viewer the URLs associated with the timecode. This is done according to the expressed preference of the viewer and may be by any of the following:

1. An IM message
2. An email message

### 3. An SMS

4. The addition of the URLs to a nominated bookmarking tag or web page
5. Immediately playing an internet video referred to by the URL.

In a typical embodiment of this aspect of the invention the URL will come from the producer of the TV programme or internet video and will be in a form that is used by conventional Internet advertising services (e.g. the DART service from Double click).

The Vidibox will display conventional microblogging messages (e.g. Twitter messages) as subtitles during the playback of a TV programme or Internet video. This aspect of the invention operates in three phases:

1. A set-up phase
2. A blogging phase
3. A playback phase

In the first phase a viewer gives the Vidibox details of his microblogging account.

In the second phase, a viewer indicates to the Vidibox that he is going to watch a particular TV programme or internet video while microblogging. The Vidibox publishes to the microblogging site a message for each playback interaction with the viewer:

1. Each time the viewer activates the play function.
2. Each time the viewer activates the pause button.
3. Each time the viewer navigates to a specific timecode in the TV programme or Internet video (e.g. a jump to a bookmark).
4. When the viewer presses stop or otherwise stops microblogging.

The first microblogging message encodes a reference to the TV programme or the internet video (e.g. as a URL) in a format that is readily parsed by other Vidiboxes. Each subsequent microblogging message generated by the Vidibox describes the playback timecode when the interaction completed. The viewer writes microblogging messages in the normal way (e.g. via SMS) as they watch the TV programme or internet video.

In the third phase a viewer indicates to a Vidibox that they wish to follow a particular microblogging site. The Vidibox obtains the microblogging messages and locates each message that marks the start of a microblogging session where the content is available (i.e. where the internet video is still accessible or where the PVR function has begun or finished recording the TV programme). The Vidibox presents the available sessions to the viewer to choose a particular one to play.

The Vidibox plays back a microblogging session by playing the TV programme or internet video. The Vidibox reads each message marked with a timecode and computes the offset between real-time and the timecode. The current offset is applied to the real-time of each subsequent normal message published to give its timecode time. The Vidibox then communicates each normal message to the viewer at the appropriate timecode during playback. This communication can be direct using the TV screen (e.g. appearing as subtitles over the TV programme or video) or indirectly (e.g. sending IM messages to a nominated account).

The microblogging session can be followed by another viewer before the session has been completed by the microblogger. In this case it is possible that the implied timecode for microblogging messages is behind the timecode of the playback by the viewer following the session (e.g. if the microblogger paused the playback and the follower caught up). In this case the Vidibox indicates to the viewer with visual or audible motifs that they are ahead of the microblogger.

### Collective Intelligence

The Vidibox uses information from the collective viewers to provide intelligent support to the viewer. The PVR inside the Vidibox will speculatively record TV programmes based on an assessment of the interests of the viewer.

Speculative recording operates as follows:

1. Each time a viewer watches a recorded TV programme or watches a catch-up TV service (e.g. BBC iPlayer, Hulu) the details of the viewing are sent to a conventional server connected to the Internet. The details include the TV programme and what proportion of the programme was watched.
2. The server correlates the viewing habits of viewers across multiple Vidiboxes and determines the likelihood of any given TV programme being of interest to each viewer. The server may infer that viewer using the catch-up TV service regularly watch an episode of a particular TV series is likely to be interested in the original TV programme.
3. The server keeps for each viewer a list of TV programmes of likely interest to the viewer with an indication of the likelihood. This list may be augmented by TV programmes from other sources (e.g. a list of programmes that the broadcaster wishes to promote to viewers with particular interests). The server periodically sends this list to the Vidibox using conventional Internet messaging protocols (e.g. XMPP).
4. The Vidibox adds these programmes to the list of feeds for the PVR function, with a priority that reflects the likelihood of interest and whether the recording is speculative or not (see the earlier description of the PVR function).
5. When the viewer later comes to view a TV programme using a catch-up TV service the Vidibox determines whether the particular TV programme selected has is available to play from local storage. If it is available then the Vidibox may play this in preference to using the Internet catch-up TV service.

The collective intelligence aspect of the invention may infer information about the content of a TV programme or Internet video and offer the viewer the ability to skip segments of a TV programme or Internet video.

This aspect operates as follows:

1. The viewer selects a recorded TV programme or internet video and begins to watch it.
2. When the viewer skips over a part of the TV programme or video the Vidibox sends to the server a description of the timecode when a sequence of skips started and when they finished.
3. The server correlates the skipping pattern from several viewers who have watched a particular TV programme or internet video and determines using conventional statistical analysis the likely interesting regions of the TV programme or Internet video. These points are associated with the TV programme or Internet video as metadata.
4. When a viewer later starts watching a TV programme or Internet video the Vidibox fetches from the server the list of timecode points for each skip region.
5. When the playback reaches the timecode of the beginning or end of a region the Vidibox indicates this to the viewer using a visual or audible motif. The viewer may then select a command to skip to the next region.

The collective intelligence aspect of the invention may infer references to other TV programmes and internet videos and make this available to the viewer. For example, if people in a particular TV program referred to another TV program or an internet video then the viewer could be invited to record or watch it.

This aspect operates as follows:

1. A TV programme or series may be added to the recording schedule or a URL to an Internet video may be added to a collection in the Vidibox. This may be done directly with the user interface on the Vidibox or externally with conventional communication with the Vidibox (e.g. an email, an XMPP message from a web site).
2. If the Vidibox is playing or has paused an Internet video or TV programme then the Vidibox sends a message to a server with details of the addition, details of the TV programme or internet video being watched, and the timecode of the playback point.
3. The server correlates the information from several Vidiboxes and determines the likelihood that the added recording or URL is linked with a particular timecode in the played TV programme or internet video. A link point is created that describes linked TV programme or internet video and the timecode for the link. The link point is associated with the played TV programme or video.
4. When a later viewer watches the TV programme or internet video the Vidibox fetches from the server a list of link points.
5. When the playback reaches the timecode of a link point the Vidibox may indicate a link to the viewer using a visual or audible motif. The viewer may then select a command to add the linked TV programme to the recording schedule or the linked internet video to a collection.

### Internet Video Tuner

An aspect of the invention is the ability to play an internet video in a standard format (e.g. Adobe Flash) from a conventional web site scaled to a full TV screen and controlled using a conventional remote control in the same or a similar way as for the PVR function of the invention.

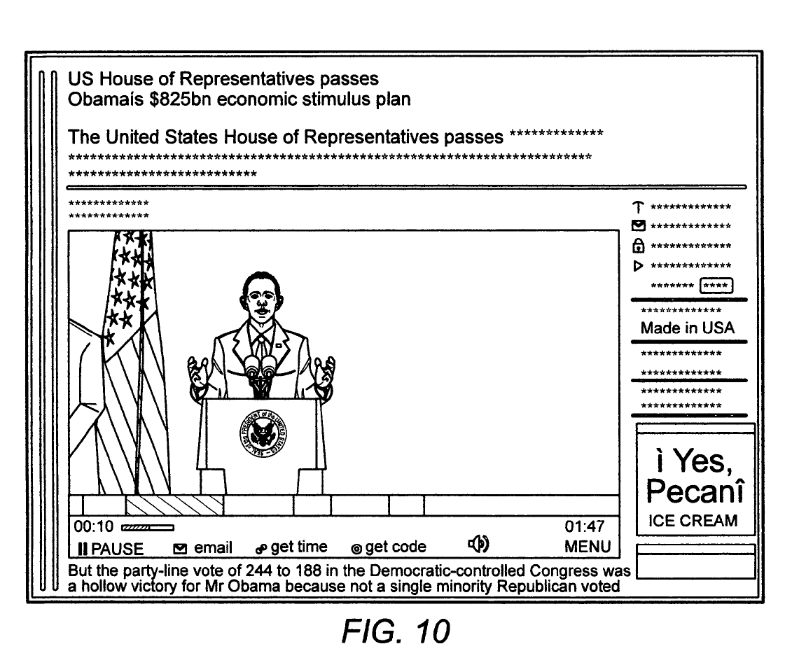

FIG. 10 shows a typical Internet video web page.

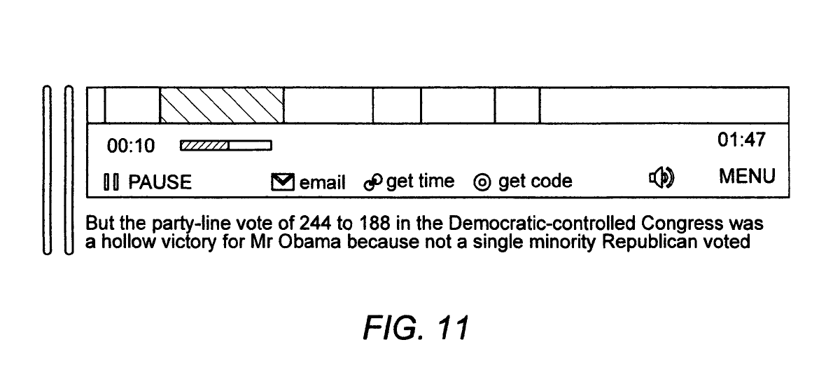

The video embedded on a web page contains a web video player. This provides controls for watching the video. FIG. 11 shows an example of web video player.

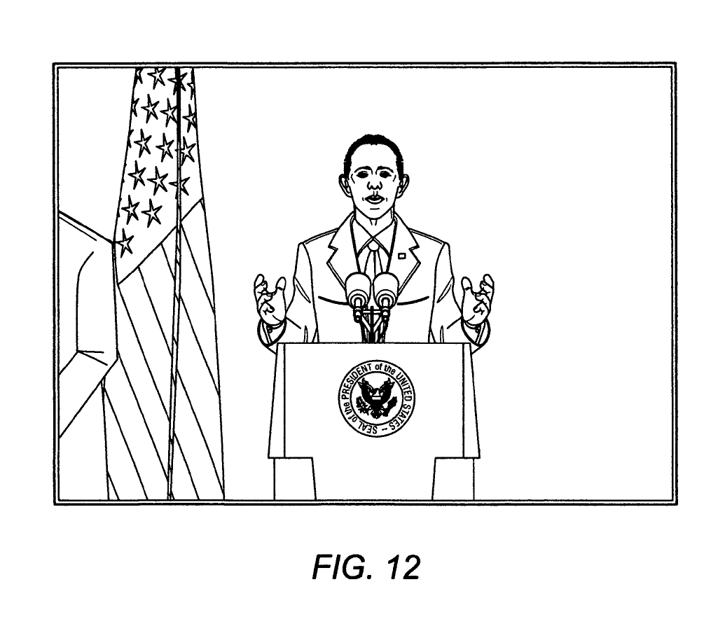

The internet flash tuner uses conventional web browsing technology to obtain the video data separately from the controls and then scales it for a TV screen as illustrated in FIG. 12.

The tuner operates as follows:

1. The Vidibox contains a database of web video player rules. These rules describe how certain standard functions are performed for known web video players observed on the Internet: the mouse and keyboard operations performed to start playback, to seek to a certain point, to stop playback, and how to obtain timecode information. In a typical embodiment of the invention these rules are codified as executable script files (e.g. JavaScript). The scripts have access to conventional functions that send simulated mouse clicks and keyboard presses to the web video player. The scripts can read the graphical output of the web video player and can invoke conventional optical character recognition (OCR) functions to interpret these regions. The database also contains a description of how to obtain just the video part of the web page.
2. The Vidibox also contains a database of a set of web site rules. These rules describe how to locate the specific internet video within a web page for known web sites on the internet and which web video player is used by each site. In a typical embodiment of the invention these rules are codified as executable script files (e.g. JavaScript). The default behaviour if there is no match is to select the largest video.
3. When the viewer instructs the Vidibox to play a particular internet video URL a convention web rendering engine is invoked internally to obtain the web page at the URL. The Vidibox then indexes the web site rules database with the URL to obtain the rules for the specific URL, with default rules substituted if no match is found. In a typical embodiment of the invention this results in the execution of a script.
4. When the Vidibox wishes to skip to a given position the appropriate rules are invoked to perform this operation. In a typical embodiment this entails the execution of a script that uses OCR functions to identify the time code and simulates mouse click-and-drag operations in a conventional feedback control loop until the appropriate timecode has been located.
5. The video playback to the TV is obtained by extracting the video part of the playback from the web video graphics. In a typical embodiment this is done by modifying the system graphics drivers in the Vidibox so that the view is cropped to just the video part using geometry rules from the database.

### Transcoding Function

An aspect of the invention is the transcoding of locally-stored TV programmes into a compressed format. It operates as follows:

1. The transcoding function periodically inspects a database of TV programmes recorded by the PVR function and identifies candidates for transcoding. In a typical embodiment a candidate is obtained by the viewer applying special tags to such TV programmes.
2. A new copy of each candidate TV programme is made using a conventional transcoder algorithm. The conversion is done at low priority using spare CPU time so that the main functions of the Vidibox are not disturbed. In the preferred embodiment of the invention this is a conversion from DVB-T MPEG2 to MPEG4 H.264 at 480×320 resolution (i.e. compatible with the iPhone).
3. The converted video files may be stored in a special part of the file system in the Vidibox that is shared on the LAN using a conventional file sharing protocol (e.g. CIFS).
4. Once conversion is complete the original TV programme recording may be lowered in priority. If the viewer subsequently selects the original TV programme for playback and it has been deleted by the PVR function then the Vidibox may alternatively play the converted programme if available.

FIG. 2 shows an embodiment of display device (called hereafter a ‘vidibox’) [FIG. 2:1] which is connected to a display (e.g. a TV) [FIG. 2:2] and the internet via a suitable interface (e.g. WiFi). The vidibox is able to display digital video from a conventional video web site (e.g. YouTube) [FIG. 2:4] by being sent a web link (i.e. a URL) to a particular web page [FIG. 2:5] and control the playback using a remote control device [FIG. 2:3]. The link is sent to the vidibox by various methods including existing email, instant messaging (IM), social networking applications (e.g. Twitter) and RSS feeds. In general this involves a communication server that generates or passes on the links [FIG. 2:6] from other sources (such as a personal computer [FIG. 2:7] with a web browser [FIG. 2:8] or email client program [FIG. 2:9]). This methods by which the invention takes a URL and displays the video on the corresponding page is the subject of patent application(s) GB0906272.0 and/or GB0919222.0

Another aspect of the invention herein described is an improvement to the method by which URLs are exchanged between computers and vidiboxes. The rationale for the invention is that the video watching experience can be enhanced by the receiving system acting on certain metadata included with the URL. The invention pertains to metadata that includes a textual description of the video (such as its title) and refers to a particular place in the video (hereafter called a PlaySpot™) that is of special interest. The combination of the metadata and the URL to the video is called hereafter a ‘VidiLink’ and stored in a database [FIG. 2:10]. A web server [FIG. 2:11] takes the VidiLink data and displays a web page [FIG. 2:12] containing the metadata and the URL. The page also contains a set of operations that can be performed on the data by the web server or the web browser [FIG. 2:8] or a program on the computer (e.g. an email client [FIG. 2:9]).

The following diagram (FIG. 3) shows an example of how the web page [FIG. 2:12] might look:

The URL for the web page is a short URL intended to fit comfortably into short messages (e.g. Twitter messages) [FIG. 3:1], hereafter referred to as a VidiURL. A VidiURL is an index into the database [FIG. 2:10] containing the corresponding VidiLink that allows the web server to serve the appropriate content on the page. The server displays the textual metadata (e.g. title, description) with a button or hyperlink for navigating to the target URL [FIG. 3:2]. In some cases the target video may be included on the VidiURL page (this is referred to as ‘embedded’) [FIG. 3:3].

Operations to control the playback may be included on the VidiURL web page [FIG. 3:4]. One of these may be a button to skip to the PlaySpot. The implementation of these buttons varies according to the specific details of how each video web site [FIG. 2:4] operates. The general method is for the button to trigger a command to the playback mechanism (e.g. a video player encoded in Adobe Flash) to seek to the timecode in the video corresponding to the PlaySpot metadata value. For example, the YouTube Flash video player provides an API for JavaScript programs to seek using the playerseekTo( ) function.

Operations to control the sharing of the VidiURL itself [FIG. 3:1] are provided [FIG. 3:5] on the VidiURL web page. This can be sharing via email (for example, providing a mailto: link that pre-populates an email with the subject set to the title of the video and the body including the description and the VidiURL) [FIG. 3:6]. Other sharing options including posting the VidiURL to social networks [FIG. 3:5] for which a common embodiment is to use a button provided by the AddThis company (www.addthis.com).

Operations are provided on the VidiURL web page to immediately send the VidiURL to a vidibox associated with the user. A typical embodiment of the invention identifies the user using account login authentication and obtains the details of the user's associated vidiboxes. A button for sending to a particular vidibox is created which sends the VidiURL to the corresponding vidibox. In a typical embodiment of the invention this is done by the browser instructing the server to send a message to the vidibox containing the VidiURL [FIG. 3:1]. An alternative embodiment of the invention is for the buttons to be a mailto: link that pre-populates an email message (as described earlier [FIG. 3:5]) but with the ‘To:’ field set to the email address of the corresponding vidibox.

Operations are provided on the VidiURL web page to add the viewed VidiURL to a playlist [FIG. 3:7]. A playlist consists of an ordered list of VidiURLs and metadata held in a database associated with the user (the user can be identified through authentication against a registered account or can be anonymous and identified only by a web browser cookie). Browsing to a URL for the playlist [FIG. 4:1] shows the user's current playlist. An example of the contents of the playlist web page is illustrated in the diagram below [FIG. 4]:

A playlist has associated with it metadata as for a VidiLink, including title [FIG. 4:2] and textual description [FIG. 4:3]. It also has an ordered list of VidiURLs [FIG. 4:5]. The PlaySpot metadata for a playlist indicates the VidiURL within the playlist and the timecode within that video [FIG. 4:4]. Operations are included to reorder the playlist and to delete items from it [FIG. 4:6] as well as to save or cancel operations on the playlist [FIG. 4:7]. An operation is included to create a VidiURL from the current playlist [FIG. 4:8]. This operation instructs the web server to create a VidiLink in a database that reflects the state of the playlist and to create a URL for the VidiLink. When the operation completes the browser shows the newly-created playlist VidiURL. An example of how this page could look is shown below [FIG. 5]:

A playlist VidiURL page looks very similar to a normal VidiURL page described earlier. For example, it has the same sharing operations [FIG. 5:2]. Instead of linking to a single video web page, it links to several VidiURL pages [FIG. 5:1]. The embedded video playback includes the same operations to jump to the PlaySpot [FIG. 5:3] and new operations to skip between videos in the playlist [FIG. 5:4].

An aspect of the invention is that a playlist VidiURL can itself be added to a playlist and consequently playlists of playlists are possible in a hierarchical manner.

When a vidibox receives a VidiURL from a communications server [FIG. 2:6] it parses the page and obtains the target URL. If the VidiURL is a playlist then the parsing becomes recursive to find the eventual target video URLs. In a typical embodiment of the invention the VidiURL page encodes the metadata in an easily parsed format such as XML. The vidibox also obtains the metadata associated with each VidiURL and displays this appropriately (for example, the title of the video is displayed in a short list, with description information when requested by a user command using the remote control). The vidibox also uses the PlaySpot data when available to offer the user the opportunity to skip directly to the corresponding point in the video (or to skip to a particular place in a particular video in a playlist). In a typical embodiment of the invention this is done by offering a ‘play from the start’ and a ‘play from the PlaySpot’ option using an on-screen user interface. If the VidiURL is a playlist then the vidibox can offer the user the chance to skip between videos in the list (or between playlists if the VidiURL represents a hierarchical playlist).

The user of a vidibox can instruct it to send a link to people or other vidiboxes for a selected video or playlist (for example as a recommendation to a friend). The vidibox carries out this instruction by communicating with the VidiURL database [FIG. 2:13] to create a VidiLink corresponding to the video or playlist and obtaining a VidiURL for the VidiLink. The PlaySpot value for the VidiLink can be set according to the user's wishes (including a particular bookmarked timecode or the most recent played point in the video or playlist). The resulting VidiURL is shared to people or other vidiboxes using conventional communications methods (as discussed earlier) including email, IM and social networking [FIG. 2:6].

VidiURLs can be created not just by a vidibox but also by a user with a web browser filling in the appropriate fields of a web form. An example of how this form might look is shown below [FIG. 6]:

The creation web page [FIG. 6:1] includes fields for the title [FIG. 6:2], a PlaySpot [FIG. 6:3], a textual description [FIG. 6:4] and the target web video page's URL [FIG. 6:5]. Operations are included to save the form and create a VidiURL or to cancel the creation.

Some of the fields in the form can be filled out automatically if the web page is opened by means of a bookmarklet [see http://en.wikipedia.org/wiki/Bookmarklet] (or some other form of browser extension capable of executing program code). When the user is viewing a web page containing video that they wish to share with a vidibox or someone else they activate the bookmarklet in the browser. An example of this is shown in the diagram below [FIG. 7]:

The bookmarklet [FIG. 7:1] opens a new window containing the web form with the title populated from the title of the original video page, and the target URL derived from the URL of the original page. If the original page offers an API to interrogate the video player embedded on the page it is possible to automatically populate the PlaySpot from the current playback position of the video in the original page. For example, with the YouTube player API the JavaScript command player.getCurrentTime( ) obtains the playback point.

It is possible that the original page only offers an API to access the playback state if the URL is formed in a certain way. For example, the YouTube API is only available if the URL includes the parameter enablejsapi=1. When a VidiURL is created from the VidiLink in the database [FIG. 2:10] the target URL on the page is set to enable the API. A browser extension can be used to automatically perform URL rewriting even when a VidiURL is not used to direct the user at the video.

A VidiURL with a PlaySpot can be received on a computer via email, IM, social networking, or some other source, from either a vidibox or another computer [FIG. 2:14]. A second bookmarklet (or browser extension) is used as a control to jump the video playback straight to the PlaySpot. This jump bookmarklet uses the same principles as for operations on videos embedded in a VidiURL page [FIG. 3:4] described earlier. For example, with YouTube videos the player.seekTo( ) command can be used. The jump bookmarklet obtains the PlaySpot value by obtaining the VidiURL that referred the page to the video page (in a typical embodiment of the invention by using the document.referrer call in JavaScript) and extracting the PlaySpot value from the VidiURL web server [FIG. 2:11].

It is of course understood that the invention is not intended to be restricted to the details of the embodiment set out in the present application which are described by way of example only.

As used herein, any reference expressed in the form FIG. 2; 11 indicates the reference numeral of a part numbered 11 in FIG. 2.

1. An improved television and video system comprising a system device connected to multiple TV and video sources and which is operable to obtain TV and video signals from one or more of said sources, said system device also being operable to monitor the TV and video being watched by a viewer and being operable to obtain from one or more of said sources video and/or TV signals appropriate to that viewers tastes.

2. An improved system according to claim 1 wherein said system comprises a Vidibox (as defined herein).

3. An improved system according to claim 1 wherein said Vidibox is operable to access the internet to obtain video signals made by appropriate servers.

4. An improved system according to claim 1 wherein said Vidibox operable to access said fixed non volatile storage media, example hard disk or solid state.

5. An improved system according to claim 1, in which external connections to the box are provided for example USB, firewire connectors.

6. An improved system according to claim 1, in which said system is connectable to a network for access to storage (NAS) devices using one of the standard lan examples CIFS, NFS, AFE.

7. An improved system in accordance with claim 1, in which the Vidibox is configured so as to able to exchange messages, example instant messaging (IM or XMPP) and of e-mail communications.

8. An improved system according to claim 2, wherein said Vidibox is operable to access the internet to obtain video signals made by appropriate servers.

9. An improved system according to claim 2, wherein said Vidibox is operable to access said fixed non volatile storage media, example hard disk or solid state.

10. An improved system according to claim 3, wherein said Vidibox is operable to access said fixed non volatile storage media, example hard disk or solid state.

11. An improved system according to claim 2, in which external connections to the box are provided for example USB, firewire connectors.

12. An improved system according to claim 3, in which external connections to the box are provided for example USB, firewire connectors.

13. An improved system according to claim 4, in which external connections to the box are provided for example USB, firewire connectors.

14. An improved system according to claim 2, in which said system is connectable to a network for access to storage (NAS) devices using one of the standard lan examples CIFS, NFS, AFE.

15. An improved system according to claim 3, in which said system is connectable to a network for access to storage (NAS) devices using one of the standard lan examples CIFS, NFS, AFE.

16. An improved system according to claim 4, in which said system is connectable to a network for access to storage (NAS) devices using one of the standard lan examples CIFS, NFS, AFE.

17. An improved system according to claim 5, in which said system is connectable to a network for access to storage (NAS) devices using one of the standard lan examples CIFS, NFS, AFE.

18. An improved system in accordance with claim 2, in which the Vidibox is configured so as to able to exchange messages, example instant messaging (IM or XMPP) and of e-mail communications.

19. An improved system in accordance with claim 3, in which the Vidibox is configured so as to able to exchange messages, example instant messaging (IM or XMPP) and of e-mail communications.

20. An improved system in accordance with claim 4, in which the Vidibox is configured so as to able to exchange messages, example instant messaging (IM or XMPP) and of e-mail communications.
